(19) United States
(12) Patent Application Publication
(10) Pub. No.: US 2011/0155501 A1
(43) Pub. Date: Jun. 30, 2011

(54) DIAPHRAGM FOR ELECTROACOUSTIC TRANSDUCER

(75) Inventor: HWANG-MIAW CHEN, Tu-Cheng (TW)

(73) Assignee: Foxconn Technology Co., Ltd., Tu-Cheng (TW)

(21) Appl. No.: 12/723,711

(22) Filed: Mar. 15, 2010

(30) Foreign Application Priority Data
Dec. 30, 2009 (CN) 200910312821.8

(51) Int. Cl. H04R 7/00

(52) U.S. Cl. 181/167

(57) ABSTRACT

An exemplary diaphragm includes a first member and a second member attached to the first member. The first member is made of polyetherimide, and the second member is made of polyethylene terephthalate.

### BACKGROUND

1. Technical Field

The disclosure generally relates to electroacoustic transducers, and particularly to a diaphragm of an electroacoustic transducer.

2.Description of Related Art

With the continuing development of audio and sound technology, electroacoustic transducers have been widely used in electronic devices such as mobile phones, computers, televisions and other devices providing audio capabilities.

The basic speaker, in which electric energy is converted to acoustic energy, is a typical form of an electroacoustic transducer. There are many different types of speakers, e.g., electrostatic speakers, piezoelectric speakers, and moving-coil speakers. Moving-coil speakers are very popular due to their low cost and wide sound range.

A typical moving-coil speaker includes a diaphragm, a voice coil joined to the diaphragm, a magnet, and a circuit board. When an oscillating electric current is supplied to the voice coil from the circuit board, a corresponding oscillating magnetic field is generated by the voice coil. The oscillating magnetic field is superimposed onto a magnetostatic field generated by the magnet. This compels the voice coil to oscillate, and the oscillating voice coil thus drives the diaphragm to push ambient air to generate sound. However, during oscillation of the diaphragm, radial movement of the diaphragm reduces the sound output quality of the speaker. Therefore, a rigidity of the diaphragm needs to be sufficient in order that the sound output quality of the speaker is satisfactory.

What is needed, therefore, is a diaphragm for an electroacoustic transducer which can enable the sound output quality to be high.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the various views.

FIG. 1 is a schematic, isometric view of a diaphragm in accordance with one embodiment of the disclosure.

FIG. 2 is a cross sectional view of the diaphragm of FIG. 1, taken along line II-II thereof.

FIG. 3 is a graph indicating sound frequency response curves of two exemplary diaphragms, each diaphragm corresponding to the diaphragm of FIG. 1, with the two diaphragms have different thicknesses.

FIG. 4 is a graph indicating sound distortion curves of the two exemplary diaphragms described in the above paragraph.

### DETAILED DESCRIPTION

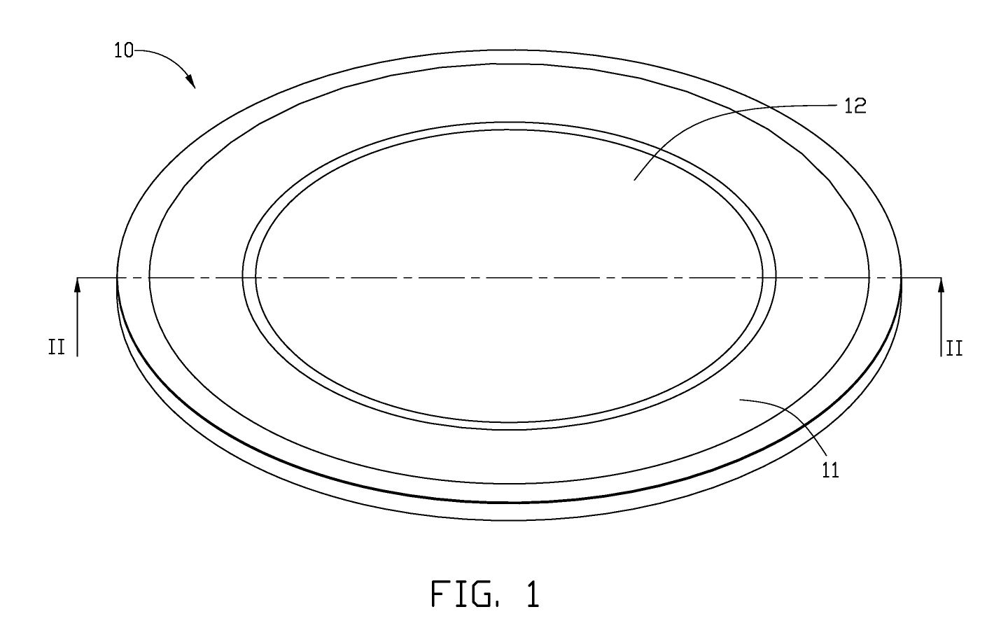

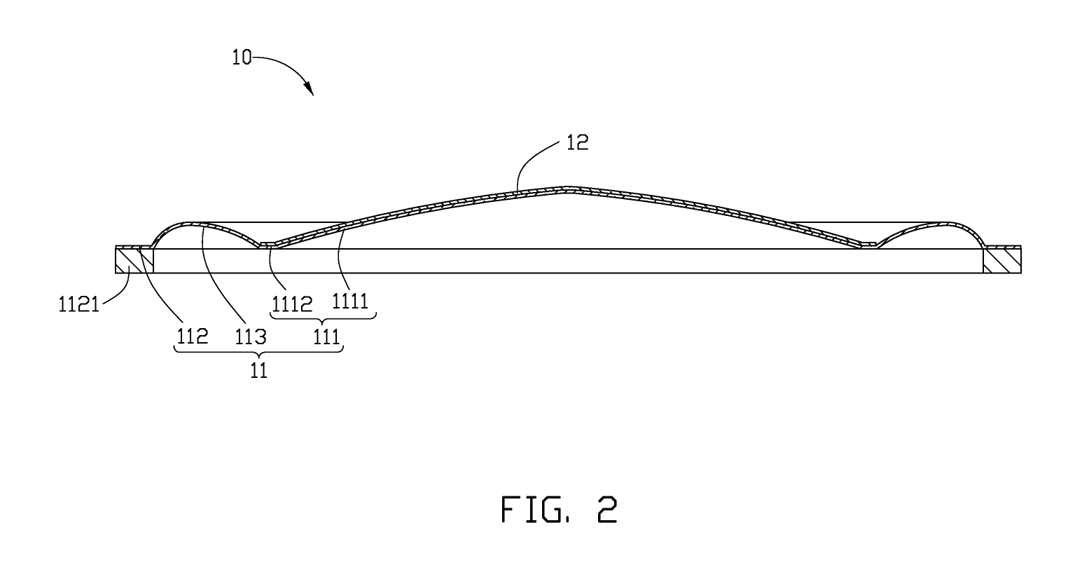

Referring to FIGS. 1 and 2, a diaphragm 10 in accordance with one embodiment of the disclosure is shown. The diaphragm 10 is for electroacoustic transducers, such as the speakers of mobile phones, computers, televisions, and so on.

The diaphragm 10 includes a base member 11 and a cover member 12 attached to the base member 11. The base and cover members 11, 12 are circular, and each have a thin cross-section.

The base member 11 is made of polyetherimide (PEI). The base member 11 has a thickness in an approximate range from 15 to 16 micrometers (μm), e.g., 15.2 μm, 15.5 μm, 15.8 μm, and so on. The base member 11 includes a central area 111 in a center thereof, a joint area 112 at an outer periphery thereof, and a connecting area 113 between the central area 111 and the joint area 112. The central area 111, the joint area 112 and the connecting area 113 are coaxial.

The central area 111 is circular. The central area 111 includes a generally dome-shaped central section 1111 at a center thereof, and a coil connecting section 1112 at an outer periphery of the central section 1111. The coil connecting section 1112 is annular and planar, and has a bottom surface configured for attaching to a top side of a voice coil of an electroacoustic transducer (not shown).

The connecting area 113 is disposed around the coil connecting section 1112, and is curved upwardly to form an annular bulge. The joint area 112 is annular and planar, and is disposed around the connecting area 113. The joint area 112 corresponds to a frame (not shown) of the electroacoustic transducer, so that the diaphragm 10 can be joined onto the frame. A copper ring 1121 is attached to a bottom surface of the joint area 112, to increase the rigidity of the diaphragm 10. The copper ring 1121 has a horizontal width substantially equal to that of the joint area 112.

The cover member 12 is glued (adhered) to a top surface of the central area 111 of the base member 11. The cover member 12 is coaxial with the base member 11, and has a same shape as the central area 111 of the base member 11. The cover member 12 is made of polyethylene terephthalate (PET). The cover member 12 has a thickness in an approximate range from 12 to 19 μm, e.g., 13 μm, 14 μm, 15 μm, 16 μm, 17 μm, 18 μm, and so on.

In the present diaphragm 10, the cover member 12 is jointed to the central area 111 of the base member 11. The cover member 12 enhances the rigidity of the diaphragm 10, particularly the rigidity at the central area 111 of the diaphragm 10. This prevents abrupt deformation of the diaphragm 10 during oscillation, and decreases radial movement of the diaphragm 10. Thereby, the sound output quality of the electroacoustic device incorporating the diaphragm 10 can be improved.

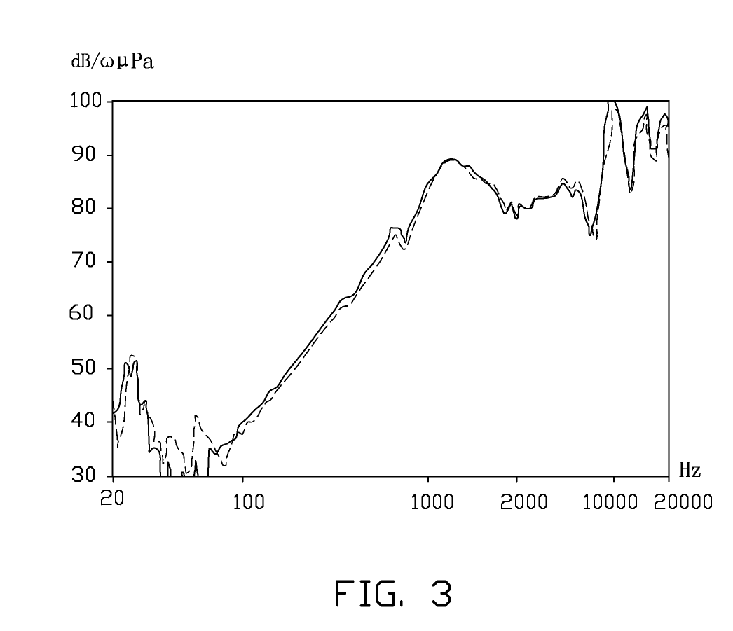

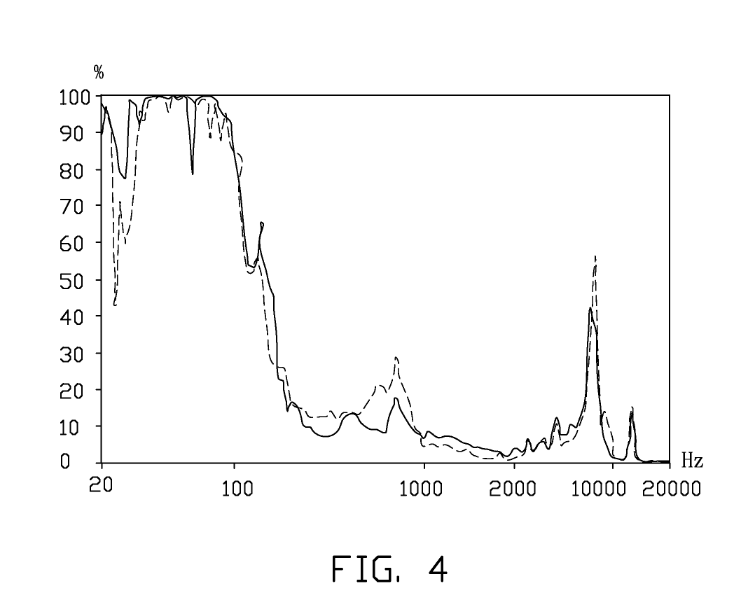

FIGS. 3 and 4 respectively show sound frequency response curves and sound distortion curves of two exemplary diaphragms 10 used in the same electroacoustic device. The two exemplary diaphragms 10 have the same structure, except for the thicknesses of their cover members 12. The base members 11 of the two exemplary diaphragms 10 have the same thicknesses, being 15 μm. The thickness of the cover member 12 of one exemplary diaphragm 10 is 16 μm, and the thickness of the cover member 12 of the other exemplary diaphragm 10 is 9 μm. Thus, an overall thickness of the one exemplary diaphragm 10 is slightly greater than that of the other exemplary diaphragm 10.

The solid curves in FIGS. 3 and 4 are those of the one exemplary diaphragm 10, and the broken curves in FIGS. 3 and 4 are those of the other exemplary diaphragm 10. As seen in FIG. 3, the low frequency response of sound of the one exemplary diaphragm 10 is obviously better than that of the other exemplary diaphragm 10, and the high and middle frequency response of sound of the one exemplary diaphragm 10 is almost equivalent to that of the other exemplary diaphragm 10. As seen in FIG. 4, the distortion of a low frequency section of sound of the one exemplary diaphragm 10 is obviously lower than that of the other exemplary diaphragm 10, and the distortion of high and middle frequency sections of sound from the one exemplary diaphragm 10 is almost equivalent to that of the other exemplary diaphragm 10. In other words, the one exemplary diaphragm 10 which is thicker has relatively better sound frequency response at low frequencies, and has relatively lower sound distortion at low frequencies. Accordingly, the electroacoustic device with the one exemplary (i.e., thicker) diaphragm 10 has better sound output quality, particularly for low frequencies.

It is to be understood, however, that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

1. A diaphragm for an electroacoustic transducer, the diaphragm comprising:
a first member comprising polyetherimide; and
a second member attached to an outer face of the first member, the second member comprising polyethylene terephthalate, an area of the second member as seen from an outer face of the second member being less than the area of the outer face of the first member;
wherein the first member comprises a central area in a center thereof, a joint area at an outer periphery thereof, and a connecting area between the central area and the joint area, the central area comprising a generally dome-shaped central section at a center thereof and an annular, planar coil connecting section at an outer periphery of the central section, the second member being attached to the central area of the first member, an outer periphery of the second member extending outwardly to cover the coil connecting section of the central area of the first member.

2. The diaphragm of claim 1, wherein the first member has a thickness in a range from 15 to 16 μm.

3. The diaphragm of claim 1, wherein the second member has a thickness in a range from 12 to 19 μm.

4. The diaphragm of claim 1, wherein the second member is coaxial with the first member.

5. (canceled)

6. The diaphragm of claim 1, wherein the second member has a shape the same as that of the central area of the first member.

7. (canceled)

8. The diaphragm of claim 1, wherein the connecting area of the first member is curved outwardly to form an annular bulge.

9. The diaphragm of claim 1, further comprising a copper ring, wherein the connecting area of the first member is generally annular, the joint area of the first member is annular, and the copper ring is attached to the joint area.

10.-11. (canceled)

12. A diaphragm for generating sound waves, the diaphragm comprising:
a base member comprising polyetherimide, and having a main outer side;
a cover member attached to a middle of the main outer side of the base member, the cover member comprising polyethylene terephthalate, and the cover member being smaller than the main outer side of the base member; and
a copper ring;
wherein the base member comprises a central area in a center thereof, a joint area at an outer periphery thereof, and a connecting area between the central area and the joint area, the connecting area of the base member being curved outwardly to form an annular bulge, the copper ring being attached to the joint area of the base member.
